(19) United States
(12) Patent Application Publication
(10) Pub. No.: US 2007/0085412 A1
(43) Pub. Date: Apr. 19, 2007

(54) Tire rim protector

(76) Inventor: Gary M. Saulnier, Camp Springs, MD (US)

Correspondence Address: LITMAN LAW OFFICES, LTD, PO BOX 15035, CRYSTAL CITY STATION, ARLINGTON, VA, 22215, US

(21) Appl. No.: 11/546,916

(22) Filed: Oct. 13, 2006

Related U.S. Application Data
(60) Provisional application No. 60/726,236, filed on Oct. 14, 2005.

(51) Int. Cl. B60B 7/00

(52) U.S. Cl. 301/37.103

(57) ABSTRACT

The wheel rim protector is a concave-convex disk for covering a vehicle wheel rim to protect the wheel rim from the application of fluids that may stain or corrode the wheel rim during detailing of the tires. The wheel rim protector has a pair of crossed ribs forming a cruciform handle to provide a grip for the user, and may have a lower lip for engagement with the wheel rim when the user presses the disk against the wheel rim. The contour of the disk permits multiple wheel rim protectors to be stacked together during transport, display or storage, and accommodates dust caps or ornamentation projecting from the wheel hub.

### CROSS-REFERENCE TO RELATED APPLICATION

This application claims the benefit of U.S. Provisional Patent Application Ser. No. 60/726,236, filed Oct. 14, 2005.

### BACKGROUND OF THE INVENTION

1. Field of the Invention

The present invention relates to a wheel rim protector. The wheel rim protector is used to cover a wheel rim during detailing of the tires in order to protect the wheel rim from staining or damage that might result from overspray of a tire dressing, sealant, cleaner or protectant being applied to the tire.

2. Description of the Related Art

Automobile wheels and tires often require detailing or cleaning. Car dealers are concerned that the wheels and tires be clean to enhance the aesthetic appeal of the car, making it easier to sell. Upon even modest use, the appearance of wheels and tires deteriorates from exposure to the elements, road conditions, brake dust, and other environmental factors. The conscientious car owner will clean and detail the wheels and tires frequently as part of a regular maintenance program to prevent degradation of the appearance and condition of the wheel rims and tires.

A great many products are available for application to the tires, in particular. Such products include dressings, sealants, cleaners, protectants, and the like. While some of the products are gels, a great many are liquids applied by aerosol spray cans. When applying spray products to the tires, it is difficult to avoid “overspray” of the tire products onto the wheel rims. Such products may stain the wheels, and may even include chemicals or compounds that may corrode the wheels.

Several types of protectors have been developed for protecting wheel rims during the detailing or cleaning of tires. However, the number of such different designs attests to the fact that, while these protectors have been effective to some degree in protecting at least some models of wheel rims, none has been found to be entirely satisfactory. In addition, such protectors are often bulky or have projecting members that prevent the protectors from being stacked for compact storage in retail establishments selling the protectors and in garages or automotive detailing facilities, or for transport. Thus, a wheel rim protector solving the aforementioned problems is desired.

### SUMMARY OF THE INVENTION

The wheel rim protector covers a vehicle wheel rim to protect the wheel rim from corrosion and staining during the application of dressings, sealants, and protectants to the tire. The wheel rim protector is a disk formed of a relatively soft, resilient material, such as soft plastic, in order to prevent damage to the wheel rim upon engagement of the wheel rim protector with the wheel rim. The protector has a pair of ribs forming a cruciform handle providing a grip for the user. The wheel rim protector also has a lower lip for engagement with the wheel rim. The ribs forming the handle further provide structural support, particularly when multiple wheel rim protectors are stacked together. The wheel rim protector is not a flat disk, but has a parabolic or concave-convex curvature, with the ribs being disposed on the convex surface, so that multiple wheel rim protectors may be efficiently stacked during transport, display or storage. Alternatively, a vertical opening or passage may be formed through the wheel rim protector along a central axis thereof, so that the wheel rim protectors may be stacked and secured on a peg or pole.

These and other features of the present invention will become readily apparent upon further review of the following specification and drawings.

### BRIEF DESCRIPTION OF THE DRAWINGS

FIG. 1 is a perspective view of a wheel rim protector according to the present invention.

FIG. 2A is an environmental, perspective view of the wheel rim protector according to the present invention, the hand of a user pressing the protector against the wheel rim being omitted to show coverage of the rim.

FIG. 2B is an environmental, perspective view of the wheel rim protector of the present invention exploded from a wheel rim.

FIG. 3 is a top view of the wheel rim protector according to the present invention.

FIG. 4 is a section view taken along lines 4-4 of FIG. 3.

FIG. 5 is a section view similar to FIG. 4 showing multiple wheel rim protectors of the present invention loosely stacked for storage or transport.

FIG. 6 is a section view of the multiple wheel rim protectors of FIG. 5 compressed together for more compact storage or transport.

Similar reference characters denote corresponding features consistently throughout the attached drawings.

### DETAILED DESCRIPTION OF THE PREFERRED EMBODIMENT

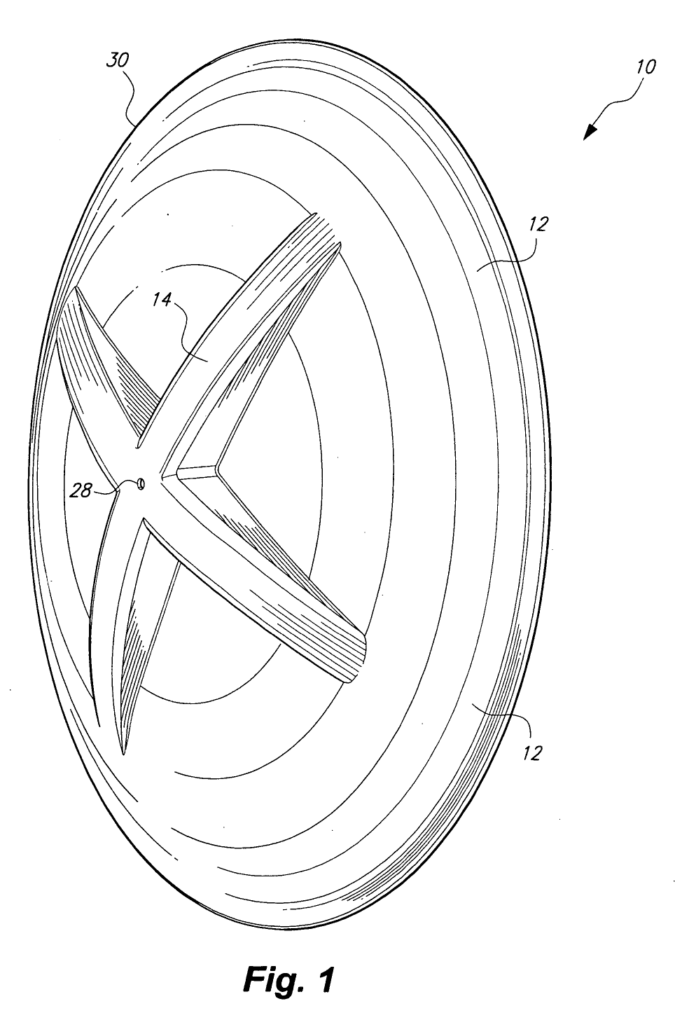

As shown in FIGS. 1-4, the present invention is a wheel rim protector 10 for protecting a wheel rim 26 during application of a tire dressing, cleaning solution, protectant, UV sealant or other detailing chemical by aerosol spray can 24 to a tire 20. The wheel rim protector 10 is formed from a lightweight, noncorrosive and washable material, such as polystyrene or other plastic materials, allowing for portability of the protector 10 and protection of wheel rim 26. As will be described in greater detail below, the wheel rim protector 10 is further formed from a resilient material, allowing multiple wheel rim protectors 10 to be stacked and compressed together without damaging the wheel rim protectors 10. The material used in the formation of wheel rim protector 10 is also relatively soft in order to prevent damage to wheel rim 26 during engagement with wheel rim protector 10.

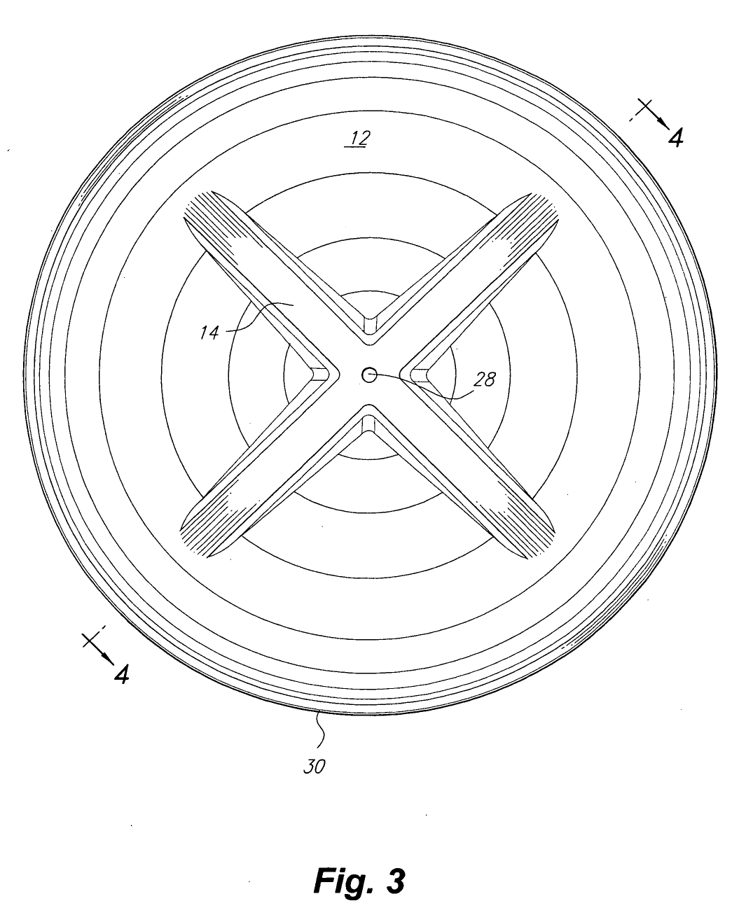

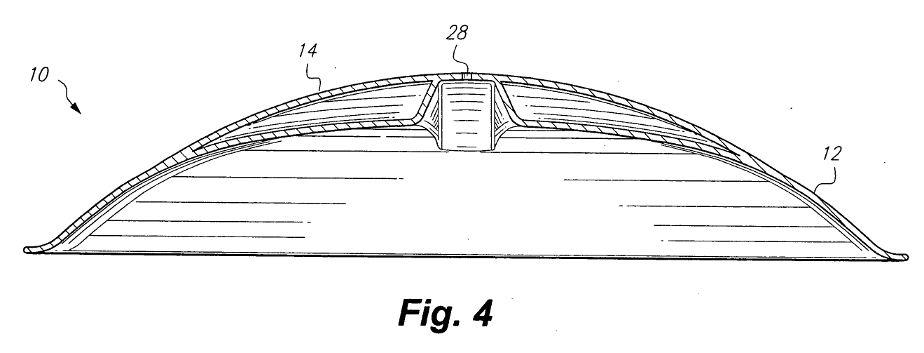

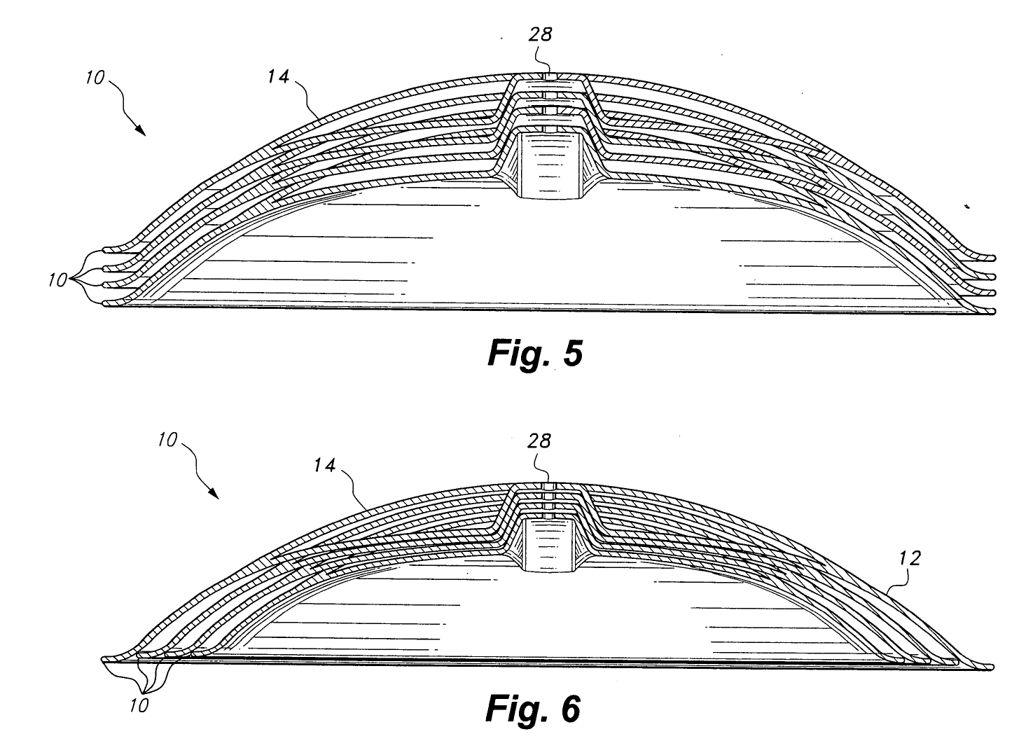

As shown in the drawings, the wheel rim protector 10 has a diskshaped body 12 having a substantially circular periphery for mating with and covering circular wheel rim 26. The disk 12, as best shown in FIGS. 1 and 4, is not flat, but has a parabolic or concave-convex configuration in section. The concave-convex configuration of the disk 12 permits multiple wheel rim protectors to be stacked for purposes of transportation, display and storage (to be described in further detail below, with regard to FIGS. 5 and 6). The concave-convex configuration also permits the disk to be approximated to or abutted against a wheel having a dust cap or ornament projecting from the hub of the wheel. The disk 12 may be made in various diameters and overall sizes to accommodate various wheel rim sizes. For example, wheel rim protector 10 can be manufactured for engagement with tires 20 having a wheel rim diameter of thirteen inches for compact cars and the like; alternatively, wheel rim protector 10 can be could be manufactured and sized for engagement with tires 20 having a wheel rim diameter of twenty inches or more (up to 26″) for heavy duty or commercial trucks, all without departing from the spirit or scope of the invention.

In a preferred embodiment, the height of the parabolic sector defined by the disk 12 is about two inches, although it should be understood that the height of disk 12 may vary according to the diameter of the periphery of the disk 12. Further, in manufacture, disk 12 may be sized to any desired diameter or, alternatively, a single large diameter disk 12 may be produced and then sized down to any desired diameter through the removal of an annular portion therefrom.

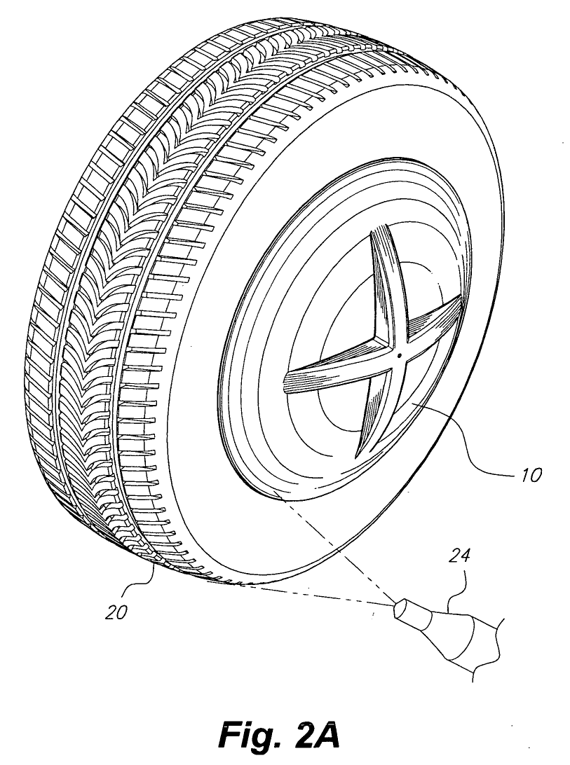

The lower edge of disk 12 has a flattened rim 30 adapted to abut the circular perimeter of wheel rim 26 when a user presses the disk 12 against the wheel rim, as shown in FIG. 2A (the user's hand is omitted in FIG. 2A to show the coverage area of the disk 12), to seal the disk 12 against the wheel rim 26, thereby preventing fluids applied during detailing the tires 20 from staining or corroding the wheel rim 26. Alternatively, an annular flange may be formed on the peripheral edge of the disk 12 for enhanced contact with the outer perimeter of wheel rim 26.

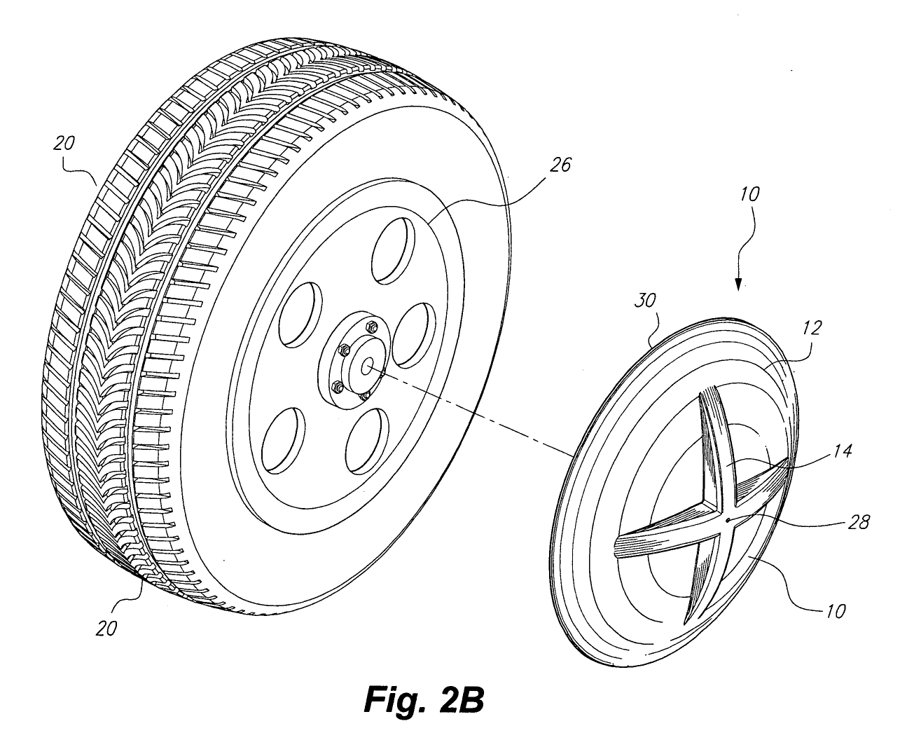

As best shown in FIGS. 1 and 3, a pair of crossed ribs form a cruciform handle 14 on the convex surface of disk 12. The crossed ribs are shown as each having an arcuate contour. However, it should be understood that this is for exemplary purposes only, and that the ribs may have any suitable contour. The handle 14 provides a recessed gripping region for the user to grasp the disk 12 and press the protector 10 against the wheel rim 26. Further, as shown in the drawings, a vertical opening or passage 28 may be formed through the upper surface of disk 12 and through the center of crossed ribs 14, allowing wheel rim protector 10 to be releasably mounted and stacked on a pole or peg during transportation, storage or display.

The crossed ribs forming cruciform handle 14 further act as structural supports, providing a degree of rigidity to the central portion of the disk 12. The outer peripheral portions of the disk between the ends of the handle 14 and the rim of the disk 12 are relatively more flexible than the central portion, so that the outer peripheral portion may extend to form a tight seal against the periphery of the wheel rim 26 when the user compresses the disk 12 against the wheel rim 26. Because of the resilience of the material, the disk 12 returns to its relaxed shape when the compressive force applied by the user is removed.

It should be understood that the orientation and contouring of cruciform handle 14 may vary within the scope of the invention as claimed. In the drawings, the ribs are shown as bisecting each other. However, this is not critical to the invention, and one rib may cross the other at a point other than the midpoint of the rib. In the drawings, the two ribs are shown as being equal in length; however, this is also not critical to the present invention. In a preferred embodiment, the relative proportions of the disk components may be a rib length of thirteen inches for a twenty-inch diameter disk 12. However, this is also not critical to the invention, and a disk 12 having a smaller diameter than twenty inches may have a cruciform handle 14 formed by ribs having a length of thirteen inches in order to maintain a conveniently sized handgrip for the user, or to maintain sufficient rigidity and structural strength in the central portion of the disk 12.

In use, the wheel rim protector 10 is applied to wheel rim 26 on which tire 20 is mounted when the user desires to cover and protect the wheel rim 26, such as during the application of a tire protectant, such as Armor All®, manufactured by the Armor All Products Corp. of Oakland, Calif. The user grasps the wheel rim protector 10 by the cruciform handle 14 formed from the crossed ribs, gripping the handle through engagement of the user's fingers with the recessed region of the ribs.

The user presses the disk 12 against the wheel rim 26 so that the lower annular edge of disk 12 engages the outer perimeter of wheel rim 26, and holds the disk 12 pressed against wheel rim 26 while applying detailing fluids from aerosol cans 24 to the tire 20 in order to protect the wheel rim 26. from overspray and to form a seal against the rim 26 to shield the rim 26 from any liquids that may otherwise drip from the tire 20 onto the wheel rim 26. The open interior of disk 12 allows for the reception and covering of any dust cap or ornaments projecting from the wheel hub. The wheel rim protector 10 is removed from tire 20 when covering and protection of wheel rim 26 is no longer needed or desired.

The contouring of wheel rim protector 10 allows for multiple wheel rim protectors 10 to be stacked together for transportation, display or storage, as illustrated in FIG. 5. The crossed ribs forming cruciform handle 14 provide structural stability to prevent wheel rim protector 10 from being overly deformed or crushed during transportation, display, storage, stacking or other harsh conditions. The wheel rim protectors 10 are formed from strong, resilient, and deformable materials, allowing stacked wheel rim protectors 10 to be compressed, as illustrated in FIG. 6, without causing damage to the wheel rim protectors 10. Additionally, a pole or peg may be inserted through passage 28, allowing multiple wheel rim protectors 10 to be secured to the pole or peg and displayed or transported thereon.

The wheel rim protector may be made in one piece by injection molding or other plastic forming processes.

It is to be understood that the present invention is not limited to the embodiment described above, but encompasses any and all embodiments within the scope of the following claims.

I claim:

1. A wheel rim protector, comprising:
a disk having a substantially circular periphery and a concave-convex shape defining a concave surface and a convex surface, the disk being dimensioned and configured for covering a wheel rim when detailing a tire mounted on the wheel rim; and
a pair of crossed ribs forming a cruciform handle on the convex surface of the disk, the cruciform handle being integral with the disk and adapted for gripping by a user in order to compress the disk against the wheel rim while detailing the tire.
